(19) United States
(12) Patent Application Publication
(10) Pub. No.: US 2026/0224923 A1
(43) Pub. Date: Aug. 6, 2026

(54) POSITIVE PRESSURE MASK

(71) Applicant: Gab Sig KIM, Anseong-si, Gyeonggi-do (KR)

(72) Inventor: Gab Sig KIM, Anseong-si, Gyeonggi-do (KR)

(21) Appl. No.: 19/150,192

(22) PCT Filed: Apr. 7, 2023
(86) PCT No.: PCT/KR2023/004764

§ 371 Date: Jul. 23, 2025

(30) Foreign Application Priority Data
Feb. 13, 2023 (KR) 10-2023-0018494

(51) Int. Cl. A62B 18/00; A62B 18/02; A62B 18/10

(52) U.S. Cl. CPC A62B 18/006; A62B 18/003; A62B 18/025; A62B 18/10

(57) ABSTRACT

A positive pressure mask includes a base part that covers areas of a nose part from below a user's eyes to a philtrum and a surrounding cheek part and has a suction valve in response to breathing through the nose part, a cover part that faces the base part is coupled to the base part along an edge portion therebetween, and partitions a space between the base part and the cover part, a supply part that supplies filtered air, a discharge pipe having one end communicating with a space between a nose of the user and the base part and the other end extending to the outside of the base part and/or the cover part, a discharge valve installed on a duct of the discharge pipe, and a discharge filter that is installed on the duct of the discharge pipe and filters air that is discharged.

### TECHNICAL FIELD

The present invention relates to a positive pressure mask that forms a double structure that covers a face of a user, continuously supplies filtered air such that a normal pressure or higher is formed inside the mask, and filters the air while achieving the supply during inhalation of the user and discharging exhalation of the user separately from the supply.

### BACKGROUND ART

In recent years, society has focused attention on a mask used to prevent diseases from fine dust or ultrafine dust caused by use of fossil fuels and to prevent infections from waterborne infectious sources in the form of bioaerosols (droplets) such as coronavirus 19 (hereinafter referred to as “COVID 19”).

In particular, an infection route of the COVID-19, which has recently been of interest, is known to be transmitted through direct contact between hands or bodies of humans or through secretions from the mouth or nose that are transmitted to the eyes, nose, mouth of an adjacent human in the form of droplets caused by breathing or sneezing of the human.

Contact infections in the above-described infection route can be prevented by distancing or using disinfectants for the COVID-19 and respiratory infections caused by secretions in the form of droplets can be prevented by wearing a pest control mask that filters out particles having a preset size in the air.

Above all, a best method for preventing spread of infection such as COVID-19 is to block inflow of infectious sources and safely discharge the infectious sources.

However, a user should remove a worn mask when eating food, and there is a concern that an infectious source of COVID-19 in the air together with the food is introduced into a respiratory system of the user through the nose and the mouth when the food is eaten in this way.

Further, the eyes of the user are not protected by the mask and may be infected by the infectious source of the COVID-19 through the eyes or by an action of wiping tears using hands.

In addition, among users, a user who wears glasses experiences inconvenience when using the mask, for example, leaking exhalation of the user through gaps between the nose and cheeks to form frost on a surface of the glasses when wearing the mask.

### Disclosure

### Technical Problem

The present invention is directed to providing a positive pressure mask that allows a user to stably inhale safe air that passes through a sterile filter in breathing of a user, discharges the air discharged by the user in a filtered state, and thus prevents the risk of infection from pathogens to the user and others around him/her.

Further, the present invention is also directed to providing a positive pressure mask which blocks inflow of external infectious sources by supplying safe air to a mouth part for food intake while a user eats food, and at the same time, in which a nose part for breathing prevents the user from being infected by pathogens during inhalation and exhalation.

Further, the present invention is also directed to providing a positive pressure mask that prevents infection from pathogens through eyes in a daily life of the user.

### Technical Solution

A positive pressure mask according to the present invention includes a base part that covers areas of a nose part from below user's eyes to a philtrum and a surrounding cheek part and has a suction valve in response to breathing through the nose part, a cover part that faces the base part, is coupled to the base part along an edge portion therebetween, and partitions a space between the base part and the cover part, a supply part that supplies filtered air by connecting a supply pipe to the space between the base part and the cover part, a discharge pipe having one end communicating with a space between a nose of the user and the base part and the other end extending to the outside of the base part and/or the cover part, a discharge valve installed on a duct of the discharge pipe, and a discharge filter that is installed on the duct of the discharge pipe and filters air that is discharged, wherein the suction valve is a check valve that opens in response to a pressure in a space between the base part and the cover part being higher than a pressure of a space between the nose part of the user and the base part, and the discharge valve is provided with a check valve that opens in response a pressure in the space between the nose part of the user and the base part being higher than a space pressure in the discharge pipe.

### Advantageous Effects

According to the present invention, clean air filtered by a supply part is supplied to a space between a base part and a cover part to maintain a positive pressure state, the air is smoothly supplied through a suction valve provided on the cover part during an inhalation process of a user, exhalation of the user is discharged via a discharge pipe and a discharge filter through a discharge valve, and thus potential infectious sources of the user can be prevented from being transmitted to others.

Further, clean air is supplied to eye parts of a user through a first opening/closing portion by a positive pressure between a base part and a cover part. Thus, an environment similar to a positive pressure state is applied to the eye parts of the user, which not only prevents pathogens from the outside through eyes of the user but also prevent problems such as fogging on a surface of glasses for the user wearing the glasses.

Further, by applying a positive pressure to a space between a base part and a cover part and supplying clean air through a second opening/closing portion, an air curtain effect is achieved. This prevents external pathogens from accessing and suppressing user infection even while a user eats food in a state in which only a mouth part is open.

In addition, as a mouth covering part of the present invention takes the form of opening or closing according to convenience of a user, clean air can be supplied to a nose of the user even while the user eats food, and a part consumed by attachment/detachment of only a portion of the mouth covering part can be minimized.

### DESCRIPTION OF DRAWINGS

FIG. 1 is a schematic exploded perspective view for describing a configuration of a positive pressure mask and an arrangement and coupling relationship of these configurations according to one embodiment of the present invention.

FIG. 2 is a schematic cross-sectional view illustrating a state in which a user wears the positive pressure mask in a state in which the respective configurations of FIG. 1 are coupled.

FIG. 3 is a schematic cross-sectional view illustrating an example of installation of a suction valve and a discharge valve on a nose covering part of FIGS. 1 and 2 and an operation relationship thereof.

### BEST MODE

A positive pressure mask according to a best mode of the present invention includes a base part that covers areas of a nose part from below the user's eyes to a philtrum and a surrounding cheek part and has a suction valve in response to breathing through the nose part, a cover part that faces the base part and is coupled to the base part along an edge portion therebetween, and partitions a space between the base part and the cover part, a supply part that supplies filtered air by connecting a supply pipe to the space between the base part and the cover part, a discharge pipe having one end communicating with a space between a nose of the user and the base part and the other end extending to the outside of the base part and/or the cover part, a discharge valve installed on a duct of the discharge pipe, and a discharge filter that is installed on the duct of the discharge pipe and filters air that is discharged, wherein the suction valve is a check valve that opens in response to a pressure in a space between the base part and the cover part being higher than a pressure in a space between the nose part of the user and the base part, and the discharge valve may be provided with a check valve that opens in response to the pressure in the space between the nose part of the user and the base part being higher than a pressure in the space on the discharge pipe.

### Modes of the Invention

In describing the present invention, expressions such as a front side or a front surface refer to a direction in which a user looks or a surface in the direction among respective components in a state in which a mask is worn by the user, and the expressions such as a rear side or a rear surface refer to an opposite direction to the front side and the front surface or a surface in the direction and refer to a direction facing a cheek of the user or a surface in the direction based on a state in which a mask is worn by the user.

In addition, in describing the present invention, the expression such as an upper side refers to a direction opposite to the direction of gravity or a portion in the direction based on a state in which the user wearing the present invention stands upright, and the expression such as a lower side refers to the same direction as the direction of gravity or a portion in the direction based on the same basis as the upper side.

Hereinafter, an exemplary embodiment of the present invention will be described in detail with reference to the accompanying drawings.

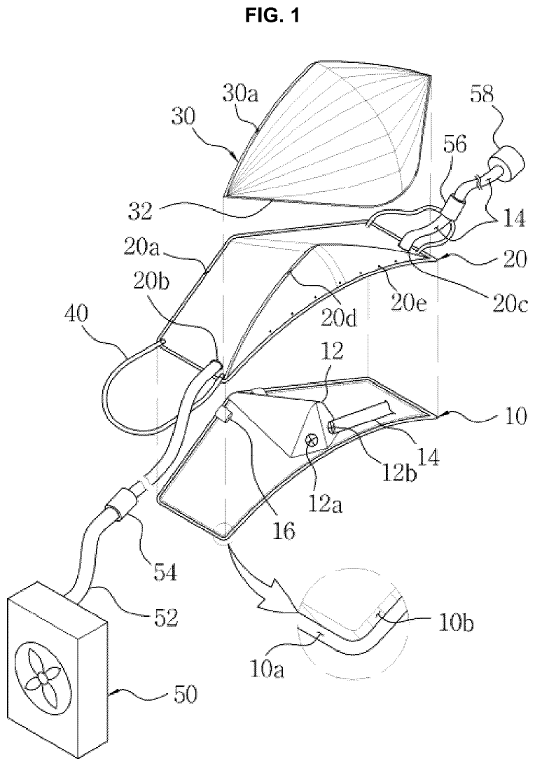

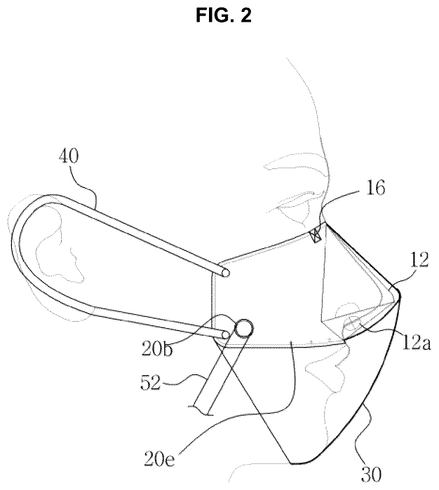

As illustrated in FIG. 1 or FIG. 2, a positive pressure mask according to the present invention includes a base part 10 that covers an area of a nose part from below a user's eyes to a philtrum of the user and a surrounding check part.

The base part 10 has a nose covering portion 12 that covers a corresponding nose part of the user in in a horizontal center part.

Further, as will be described below, a suction valve 12a is installed in the nose covering portion 12 to facilitate flow of clean air filtered through a supply part 50 in a direction of the nose of the user in response to the fact that a space A/S between the base part 10 and a cover part 20 has a higher positive pressure than a space B/S between the nose part of the user and the base part 10.

It is preferable that the suction valve 12a may be configured as a check valve that blocks flow of air from the space B/S between the nose of the user and the base part 10 to the space A/S between the base part 10 and the cover part 20, and controls the flow of air in one direction so that the flow occurs only due to a difference between an air pressure state of the space A/S between the base part 10 and the cover part 20 and a pressure state of the space B/S between the nose of the user and the base part 10 according to inhalation of the user.

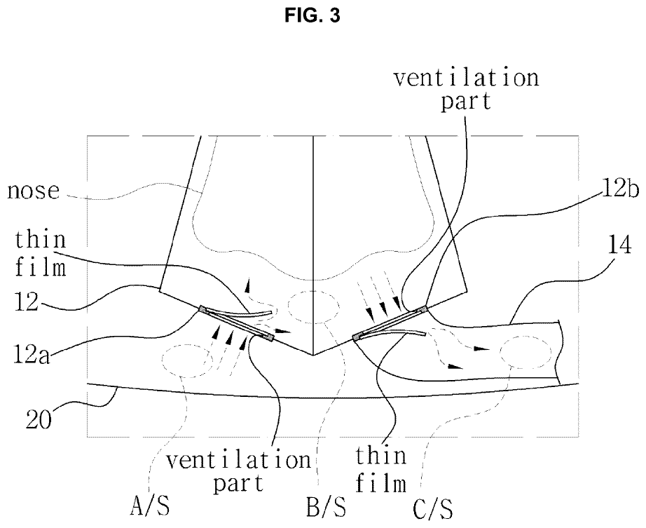

Here, in an example of the suction valve 12a illustrated in FIG. 3, a ventilation part is formed in a portion of the nose covering portion 12, the ventilation part being in a net shape with one or more holes or in a ring-shaped member passing through a hole portion. The ventilation part is deformed into an open shape when the air pressure of the space A/S between the base part 10 and the cover part 20 is greater than an air pressure of the space B/S between the nose of the user and the base part 10 which is enough to deform the film member or when the space B/S between the nose of the user and the base part 10 is in a low pressure state due to the inhalation of the user by fixing the ventilation part to one side of a flexible film member in the form of a thin film. When the air pressure of the space B/S between the nose of the user and the base part 10 in addition to exhalation of the user is greater than the air pressure of the space A/S between the base part 10 and the cover part 20, the film member is transformed into a form that closes the ventilation part to block flow of air from the space B/S between the nose of the user and the base part 10 to the space A/S between the base part 10 and the cover part 20.

It is obvious that various check valves may be applied to this suction valve 12a.

Further, the nose covering portion 12 may connect a discharge pipe 14 that discharges the flow of air caused by the exhalation of the user to the outside in the space B/S between the nose of the user and the base part 10, and in this case, a check valve-type discharge valve 12b that allows the air to flow in an direction opposite to the suction valve 12a, i.e., in a direction from the space B/S between the nose of the user and the base part 10 toward the discharge pipe 14 and blocks the flow of air in an opposite direction thereto is installed in a duct of the discharge pipe 14 including a portion of the nose covering portion 12 to which one end portion of the discharge pipe 14 is connected or one end portion of the discharge pipe 14 adjacent to the portion.

Meanwhile, the base part 10 may include a first coupling portion 10a that is coupled to an edge portion of the corresponding cover part 20 along an edge portion thereof to partition an inner space between the base part 10 and the cover part 20, and in addition, the base part 10 may further include an airtightness maintaining portion 10b that is in close contact with a surface of a face of the user facing a rear edge portion and thus prevents air from leaking out due to the exhalation of the user.

In this case, the airtightness maintaining portion 10b may be made of silicone or a material that is flexible and has excellent airtightness in the same category as the silicone and is able to be in close contact with a human skin.

Further, in the present invention, a front surface of the base part 10 is provided with the cover part 20, which faces an area of the base part 10 and is coupled each other with the edge portion corresponding to edge portion of the base part 10.

Meanwhile, in the present invention, the supply part 50 is provided for filtering and supplying air through a supply pipe 52 connected through the space between the base part 10 and the cover part 20.

This supply part 50 functions to forcibly inhale external air using a fan or pumping device and pumps the air to the space between the base part 10 and the cover part 20 through the supply pipe 52.

Further, a supply filter 54, which filters £ flowing external air out pathogens or fine dusts including infectious sources, is installed in a section through which air flows by the supply part 50 including the supply pipe 52.

That is, the supply part 50 pumps external air into the space partitioned between the base part 10 and the cover part 20 from driving thereof, and the external air flowing therefrom passes through the supply filter 54 installed on the supply part 50 including the supply pipe 52, thus forms clean air obtained by filtering out pathogens including infectious sources and fine dusts, and moves to the space between the base part 10 and the cover part 20.

The clean air, which moves in this way, passes through the suction valve 12a due to a difference between a pressure of the space between the base part 10 and the cover part 20 and a pressure of a space between the nose of the user and the nose covering portion 12 by the inhalation of the user again and is inhaled by the user.

Further, in the present invention, a discharge pipe 14 for inducing discharge for the exhalation of the user is provided.

The discharge pipe 14 may have one end communicating with the space between the nose of the user and the base part 10, i.e., the nose covering portion 12 and the other end extended to an exterior of the base part 10 via a rear surface of the base part 10.

As another example, the discharge pipe 14 may be formed in a form that passes through the nose covering portion 12, is extended through the space between the base part 10 and the cover part 20, then passes through a set portion of the cover part 20, and is extended to the outside or may be formed in a form that passes through the nose covering portion 12 and is extended to an outside of the edge along the space between the base part 10 and the cover part 20.

In addition, the discharge pipe 14 may have the discharge valve 12b installed at a portion at which the nose covering portion 12 and the cover part 20 are in contact with each other, and the discharge valve 12b itself may be formed as the discharge pipe 14.

Although FIG. 1 illustrates a structure in which a discharge port 20c is formed at an arbitrary portion of the cover part 20 and the other end extending through the discharge port 20c protrudes, the present invention is not limited thereto, and it is preferably designed to smoothly discharge exhalation air through the discharge valve 12b.

Further, the discharge valve 12b expressed as being installed at one end of the discharge pipe 14 in FIG. 1 is expressed as being formed on the nose covering portion 12, but the present invention is not limited thereto, and one end of the discharge pipe 14 may be formed in a form that passes through the nose covering portion 12 and comes close to the nose of the user.

Further, a discharge filter 56 that filters the discharged air is installed in a section from one end to the other end of the discharge pipe 14.

It is preferable that the discharge filter 56 is configured as a check valve that opens in response to a pressure in the space between the nose part of the user and the base part 10 that is greater than or equal to a normal pressure, like the supply filter 54.

In addition, a separate discharge pump 58 may be further connected to the other end of the discharge pipe 14 to ensure that the exhalation of the user passes through the discharge filter 56 and is smoothly discharged, and the discharge pump 58 may have the same configuration as the supply part 50 but only an air flow direction is opposite.

It is obvious that this discharge pump 58 is intended to compensate for a case in which flow of the exhalation of the user through the discharge pipe 14 is not smooth by the discharge filter 56, a pressure inside the discharge pipe 14 is formed to be lower than an air pressure between the nose of the user and the base part 10, but the discharge pump 58 is not necessarily installed, and may be omitted when the flow of air is smoothly performed through the discharge pipe 14 by the discharge valve 12b.

Here, it is preferable to apply a conventional method capable of selectively attaching and replacing the supply filter 54 and the discharge filter 56.

Meanwhile, a lower portion of the base part 10 or the cover part 20 may be provided with a mouth covering part 30 that is selectively coupled or decoupled and covers a mouth part of the user.

This mouth covering part 30 may be configured such that an upper portion is further connected to a lower portion of the cover part 20 or a lower portion of the base part 10 by means of a Velcro fastener, a zipper, or an adhesive or may be formed in a shape in which the lower portion of the cover part 20 extends as an integral portion of the cover part 20.

Further, the mouth covering part 30 is made of a flexible material that has breathability in the form of a general mask and may include a general filter on a front surface, on a rear surface, and between the front surface and the rear surface, and a lower portion thereof may include a band so that the lower portion may be flexibly hung on a chin of the user.

In addition, a first opening/closing portion 16 for controlling discharge of air between the base part 10 and the cover part 20 may be further provided at an edge portion of the base part 10 and the cover part 20, which is close to eyes of the user, and a second opening/closing portion 20e for controlling discharge of air between the base part 10 and the cover part 20 may be further provided at a portion corresponding to the mouth part of the user.

Here, the first opening/closing portion 16 may have a valve structure that opens or closes a passage of air according to selection of the user, and the second opening/closing portion 20e may include one or more holes for allowing air to naturally flow in a direction of the mouth from a portion of the cover part 20 corresponding to the mouth part or may be formed as a valve like the first opening/closing portion 16.

1. A positive pressure mask comprising a base part that covers areas of a nose part from below a user's eyes to a philtrum and a surrounding cheek part and has a suction valve in response to breathing through the nose part, a cover part that faces the base part is coupled to the base part along an edge portion therebetween, and partitions a space between the base part and the cover part, a supply part that supplies filtered air by connecting a supply pipe to the space between the base part and the cover part, a discharge pipe having one end communicating with a space between a nose of the user and the base part and the other end extending to the outside of the base part and/or the cover part, a discharge valve installed on a duct of the discharge pipe, and a discharge filter that is installed on the duct of the discharge pipe and filters air that is discharged,
wherein the suction valve is a check valve that opens in response to a pressure in a space between the base part and the cover part being higher than a pressure in a space between the nose part of the user and the base part, and the discharge valve is provided with a check valve that opens in response to a pressure in the space between the nose part of the user and the base part being higher than a space pressure in the discharge pipe.

2. The positive pressure mask of claim 1, further comprising a mouth covering part in which an upper portion is selectively coupled or decoupled to or from a corresponding lower portion of the base part of the cover part, a lower portion is hung on a chin of the user by a downward pulling force or is fixed to the lower portion of the base part or the cover part by an upwardly lifting action, and a portion between the upper portion and the lower portion is made of a material that is folded or unfolded and covers a mouth part of the user by the unfolding.

3. The positive pressure mask of claim 2, wherein the mouth covering part is made of a flexible material having breathability and is provided with a filter on a front surface, a rear surface, and between the front surface and the rear surface.

4. The positive pressure mask of claim 1, further comprising a first opening/closing portion configured to be at an edge portion between the base part and the cover part, close to the user's eyes, and control discharge of air between the base part and the cover part.

5. The positive pressure mask of claim 1, further comprising a second opening/closing portion configured to control discharge of air between the base part and the cover part at a portion corresponding to a mouth part of the user.

6. The positive pressure mask of claim 1, further comprising an airtightness maintaining portion formed at a rear edge portion of the base part to block inflow or outflow of air in or out of a space between a cheek surface of the user and a rear surface of the base part.
